(19) United States
(12) Patent Application Publication
(10) Pub. No.: US 2004/0001247 A1
(43) Pub. Date: Jan. 1, 2004

(54) Wavelength converter and optical cross connect system

(76) Inventor: Kazuhiro Nojima, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/601,909

(22) Filed: Jun. 24, 2003

(30) Foreign Application Priority Data
Jun. 27, 2002 (JP) 2002-187527

(51) Int. Cl. G02F 1/35; G02F 2/02

(52) U.S. Cl. 359/326

(57) ABSTRACT

Provided is a wavelength converter utilizing gain non-linearity of a semiconductor optical amplifier for suppressing the degradation of extinction ratio when an inputted signal light undergoes wavelength conversion. In the wavelength converter, a first semiconductor laser outputs an optical signal with a first wavelength to be obtained when the inputted signal light undergoes the wavelength conversion, and a second semiconductor laser outputs an optical signal with a second wavelength which is in opposite phase relation to the optical signal from the first semiconductor laser, thereby producing a Mach-Zehnder interferometer. This Mach-Zehnder interferometer enables a high level of the optical signal with the second wavelength in the opposite phase relation to cancel a low level of the optical signal with the first wavelength after passing through a semiconductor optical amplifier, thus improving the extinction ratio.

### BACKGROUND OF THE INVENTION

1) Field of the Invention

The present invention relates to a wavelength converter made to convert an inputted optical signal into an optical signal with a different wavelength, and to an optical cross connect system.

2) Description of the Related Art

So far, there has been known a wavelength converter utilizing a gain suppression phenomenon of a semiconductor optical amplifier. FIG. 12 is an illustration of a configuration of a conventional wavelength converter. In this illustration, a semiconductor laser 101 outputs an intensity-constant probe light with a converted-into-wavelength λp to be obtained when an inputted signal light with a wavelength λs undergoes wavelength conversion in the wavelength converter, and an optical coupler 102 receives the inputted signal light with the wavelength λs and the output-constant probe light with the wavelength λp from the semiconductor laser 101 and multiplexes (couples) them to output a multiplexed light with wavelengths λs+λp to a semiconductor optical amplifier 103. In this semiconductor optical amplifier 103, its gain becomes small if the intensity of the signal light is high, while the gain becomes large in conjunction with a low signal light intensity (non-linearity of gain). This gain variation carries out an intensity modulation on the probe light with the wavelength λp and this is virtually equivalent to that the signal light with the wavelength λs is converted into a signal light with the wavelength λp. Moreover, this light passes through an optical band pass filter 104 so that the signal light with the wavelength λp is extracted, thereby realizing the wavelength conversion.

There is a problem which arises with the wavelength converter with the configuration shown in FIG. 12, however, in that, when being converted into the wavelength λp, the optical signal decreases in extinction ratio. FIGS. 13A to 13D are illustrations of optical waveforms in the case of the configuration shown in FIG. 12. When an intensity-constant probe light, shown in FIG. 13A, from the semiconductor laser 101 and a signal light shown in FIG. 13B are multiplexed and inputted to the semiconductor optical amplifier 103, the output of the semiconductor optical amplifier 103 becomes as shown in FIG. 13C, where the probe light with the wavelength λp is modulated in an opposite-phase condition with respect to the signal light. If an optical signal with only the wavelength λp is extracted from the signal shown in FIG. 13C through the use of the optical band pass filter 104, a waveform appears as shown in FIG. 13D. In this case, as shown in FIG. 13D, the extinction ratio indicative of a ratio of a photoelectric power (optical level) Pp with a high level and a photoelectric power Pn with a low level becomes lower as compared with the inputted signal shown in FIG. 13B. This decrease in extinction ratio serves as a factor to produce a sensitivity degradation at the time of light reception.

### SUMMARY OF THE INVENTION

It is therefore an object of the present invention to provide a wavelength converter capable of suppressing the decrease in extinction ratio at the time of wavelength conversion to lighten the sensitivity degradation at the time of light reception.

For this purpose, in accordance with a first aspect of the present invention, there is provided a wavelength converter comprising a first semiconductor laser for outputting light with a constant intensity and with a first wavelength forming a wavelength to be obtained when an inputted signal light undergoes wavelength conversion in the wavelength converter, a first semiconductor optical amplifier for intensity-modulating the output light with the first wavelength from the first semiconductor laser through the use of the inputted signal light so that the output light falls into an opposite phase condition with respect to the inputted signal light, a second semiconductor laser for outputting a light with a constant intensity and with a second wavelength different from that of the inputted signal light and that of the output light from the first semiconductor laser, a second semiconductor optical amplifier for intensity-modulating the output light with the second wavelength from the second semiconductor laser through the use of the inputted signal light so that the output light falls into an opposite phase condition with respect to the inputted signal light, a first filter for extracting a light with the second wavelength from the output light from the second semiconductor optical amplifier, a third semiconductor optical amplifier for intensity-modulating the output light with the first wavelength from the first semiconductor laser through the use of the light with the second wavelength extracted through the first filter so that the output light falls into an opposite phase condition with respect to the second-wavelength light, multiplexing means for multiplexing the output lights from the first and third semiconductor optical amplifiers, and a second filter for extracting a light with the first wavelength from a multiplexed light from the multiplexing means.

This configuration produces an optical signal with a second wavelength in a reversed-phase condition with respect to an optical signal with a first wavelength from the first semiconductor optical amplifier and constitutes a Mach-Zehnder interferometer to make a high level of the optical signal with the second wavelength in opposite phase cancel a low level of the optical signal with the first wavelength outputted from the first semiconductor optical amplifier, thereby suppressing the deterioration of the extinction ratio.

In addition, according to a second aspect of the present invention, the foregoing wavelength converter further comprises means for adjusting optical phases of the output lights from the first and third semiconductor optical amplifiers.

Still additionally, according to a third aspect of the present invention, the foregoing wavelength converter further comprises means for adjusting optical intensities of the output lights from the first and third semiconductor optical amplifiers.

Yet additionally, according to a fourth aspect of the present invention, in the wavelength converter with the optical-intensity adjusting means, an average photoelectric power of the inputted signal light is monitored to adjust the optical intensities of the output lights from the first and third semiconductor optical amplifiers.

Moreover, according to a fifth aspect of the present invention, in the wavelength converter with the optical-intensity adjusting means, a lower-base intensity level of the optical signal is monitored through the first wavelength component of the optical output from the first semiconductor optical amplifier to adjust the optical intensities of the output lights from the first and third semiconductor optical amplifiers.

Still moreover, according to a sixth aspect of the present invention, in the wavelength converter with the optical-intensity adjusting means, a lower-base intensity level of the optical signal is monitored through the first wavelength component extracted by the second filter to adjust the optical intensities of the output lights from the first and third semiconductor optical amplifiers.

Furthermore, according to a seventh aspect of the present invention, the foregoing wavelength converter further comprises a third semiconductor laser for applying an optical signal with a constant intensity for adjustment of output light level with respect to one or more of the first, second and third semiconductor optical amplifiers.

Still furthermore, according to an eighth aspect of the present invention, in the foregoing wavelength converter including the third semiconductor laser, an average photoelectric power of the inputted signal light is monitored to control the optical output level of the third semiconductor laser.

Yet furthermore, according to a ninth aspect of the present invention, in the foregoing wavelength converter including the third semiconductor laser, a lower-base intensity level of the optical signal is monitored through the first wavelength component of the optical output from the first semiconductor optical amplifier to control the optical output level of the third semiconductor laser.

In addition, according to a tenth aspect of the present invention, in the foregoing wavelength converter including the third semiconductor laser, a lower-base intensity level of the optical signal is monitored through the first wavelength component extracted by the second filter to control the optical output level of the third semiconductor laser.

Still additionally, according to an eleventh aspect of the present invention, in the foregoing wavelength converter, a portion of or all of the components of the wavelength converter are formed on a semiconductor substrate in an integrated condition.

Yet additionally, according to a twelfth aspect of the present invention, in the foregoing wavelength converter, the first semiconductor laser is a wavelength-variable type laser.

Moreover, in accordance with a thirteenth aspect of the present invention, there is provided an optical cross connect system comprising a wavelength-demultiplexing type optical filter for demultiplexing a multiplexed optical signal with a plurality of wavelengths into a plurality of optical signals each having the corresponding wavelength, a plurality of wavelength converters, each including a first wavelength-variable type semiconductor laser for outputting light with a constant intensity and with a first wavelength forming a converted wavelength of an inputted signal light, a first semiconductor optical amplifier for intensity-modulating the output light with the first wavelength from the first semiconductor laser through the use of the inputted signal light so that the output light falls into an opposite phase condition with respect to the inputted signal light, a second semiconductor laser for outputting a light with a constant intensity and with a second wavelength different from that of the inputted signal light and that of the output light from the first semiconductor laser, a second semiconductor optical amplifier for intensity-modulating the output light with the second wavelength from the second semiconductor laser through the use of the inputted signal light so that the output light falls into an opposite phase condition with respect to the inputted signal light, a first filter for extracting a light with said second wavelength from the output light from the second semiconductor optical amplifier, a third semiconductor optical amplifier for intensity-modulating the output light with the first wavelength from the first semiconductor laser through the use of the light with the second wavelength extracted through the first filter so that the output light falls into an opposite phase condition with respect to the second-wavelength light, multiplexing means for multiplexing the output lights from the first and third semiconductor optical amplifiers, and a second filter for extracting a light with the first wavelength from a multiplexed light from the multiplexing means, and an optical coupler for multiplexing the extracted lights outputted from the second filters of the plurality of wavelength converters.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is an illustration of a configuration of a wavelength converter according to a first embodiment of the present invention;

FIGS. 2A to 2C are illustrations useful for explaining the principle of wavelength conversion according to the present invention, and of these drawings, FIG. 2A is an illustration of a probe optical output waveform, FIG. 2B is an illustration of signal light, and FIG. 2C is an illustration of an output waveform of a semiconductor optical amplifier;

FIGS. 3D to 3G are illustrations useful for explaining the principle of wavelength conversion according to the present invention, and of these drawings, FIG. 3D is an illustration of an output waveform of an optical band pass filter, FIG. 3E is an illustration of an output waveform of a semiconductor optical amplifier, FIG. 3F is an input waveform of an optical coupler, and FIG. 3G is an illustration of an output waveform of an optical band pass filter;

FIG. 4 is an illustration of a configuration of a wavelength converter according to a second embodiment of the present invention;

FIG. 5 is an illustration of a configuration of a wavelength converter according to a third embodiment of the present invention;

FIG. 6 is an illustration of a configuration of a wavelength converter according to a fourth embodiment of the present invention;

FIG. 7 is an illustration of a configuration of a wavelength converter according to a fifth embodiment of the present invention;

FIG. 8 is an illustration of a configuration of a wavelength converter according to a sixth embodiment of the present invention;

FIG. 9 is an illustration of a configuration of a wavelength converter according to a seventh embodiment of the present invention;

FIG. 10 is an illustration of a configuration of a wavelength converter according to an eighth embodiment of the present invention;

FIG. 11 is an illustration of a configuration of an optical cross connect system according to a ninth embodiment of the present invention;

FIG. 12 is an illustration of a configuration of a conventional wavelength converter; and

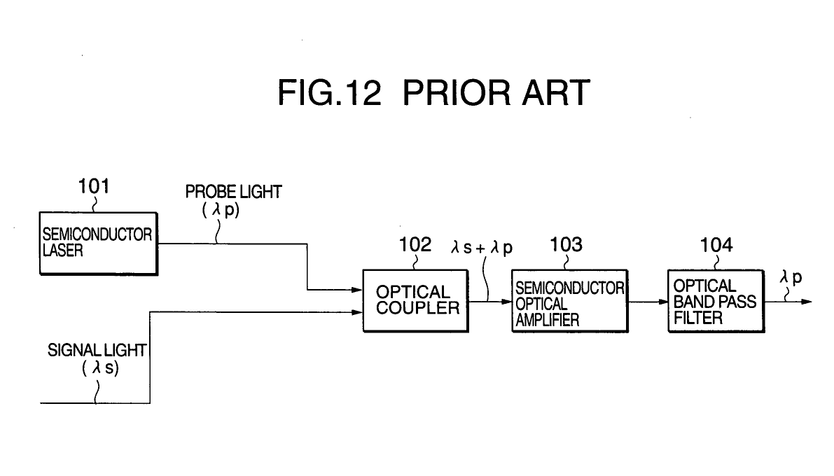

FIGS. 13A to 13D are illustrations for explaining the principle of conventional wavelength conversion, and of these drawings, FIG. 13A is an illustration of an output waveform of a semiconductor laser, FIG. 13B is an illustration of a waveform of signal light, FIG. 13C is an illustration of an output waveform of a semiconductor optical amplifier, and FIG. 13D is an illustration of an output waveform of an optical band pass filter.

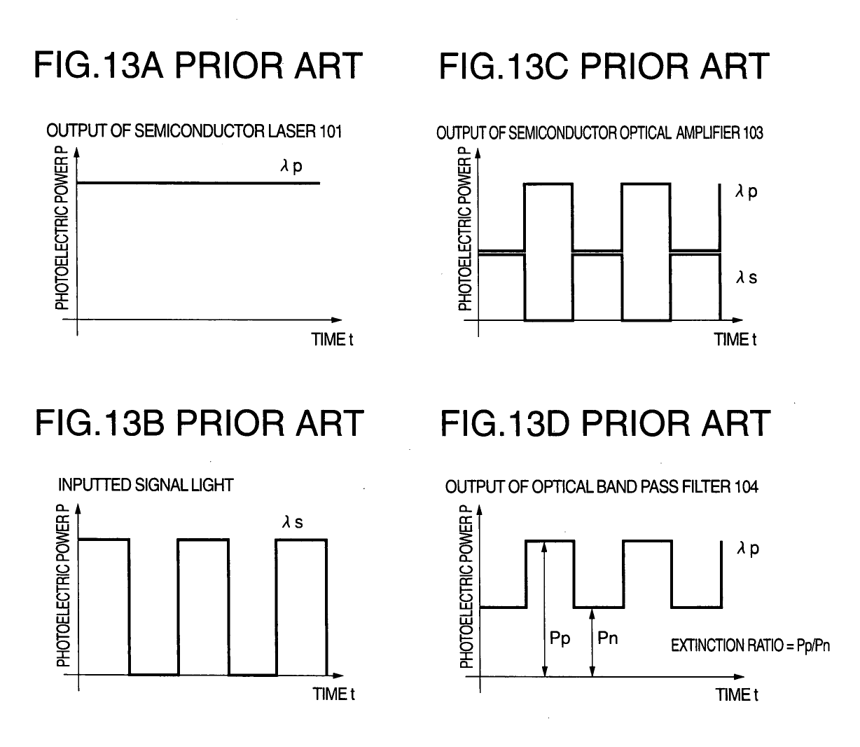

### DESCRIPTION OF THE PREFERRED EMBODIMENTS

(First Embodiment)

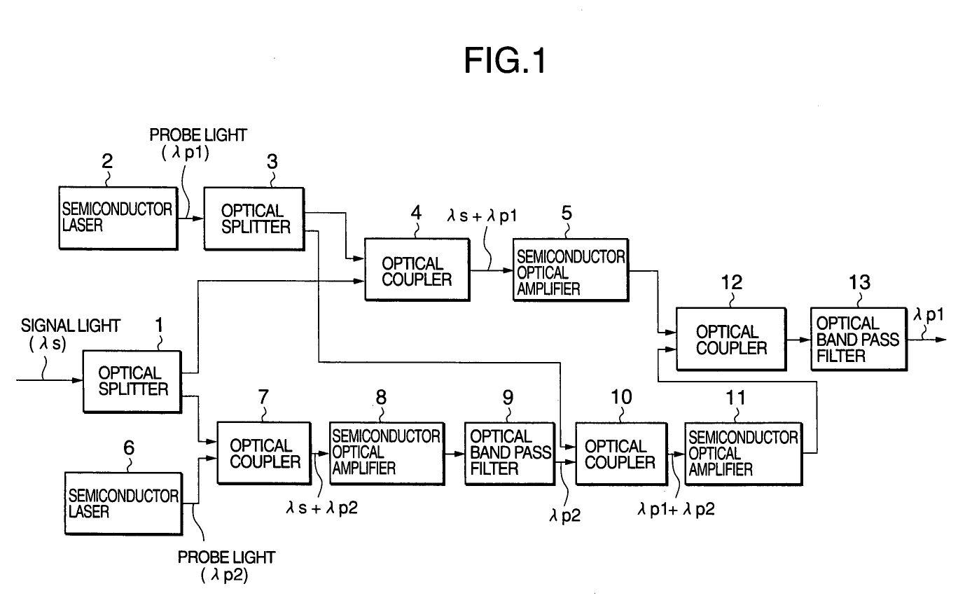

FIG. 1 is an example of configuration of a wavelength converter according to a first embodiment of the present invention. In this wavelength converter, the respective components are formed on a semiconductor substrate in an integrated condition.

In FIG. 1, in this wavelength converter, when a signal light having a wavelength λs is inputted from the external, an optical splitter 1 receives and divides the inputted signal light into two signal lights which in turn, are fed to an optical coupler 4 and an optical coupler 7, respectively. In the meantime, a semiconductor laser 2 outputs a probe light with a constant intensity and with a wavelength λp1 to be obtained when the inputted signal light with the wavelength λs undergoes wavelength conversion in the wavelength converter, i.e., a wavelength after the conversion of the inputted signal light, (which will be referred to hereinafter as a “converted wavelength of inputted signal light). The probe light with the wavelength λp1 from the semiconductor laser 2 is inputted to an optical splitter 3 to be divided into two probe lights which in turn, are fed to the optical coupler 4 and an optical coupler 10, respectively. That is, one probe light with the wavelength λp1 from the optical splitter 3 enters the optical coupler 4 while one inputted signal light with the wavelength λs from the optical splitter 1 enters the same optical coupler 4. Therefore, both the lights are multiplexed (coupled) with each other in the optical coupler 4 into a light with wavelengths λs+λp1 and are then inputted to a semiconductor optical amplifier 5 so that the probe light with the wavelength λp1 is intensity-modulated in opposite phase to the inputted signal light through the use of (on the basis of) this inputted signal light as mentioned above.

Meanwhile, another semiconductor laser 6 is additionally provided to output a probe light with a constant intensity and a wavelength λp2 different from the wavelength λs of the inputted signal light and the wavelength λp1 of the first-mentioned semiconductor laser 2, and the probe light with the wavelength λp2 is inputted to the optical coupler 7 to be multiplexed with the wavelength λs of the inputted signal light from the optical splitter 1 to produce a multiplexed light with wavelengths λs+λp2, and is multiplexed light is then inputted to another semiconductor optical amplifier 8, where the probe light with the wavelength λp2 is likewise intensity-modulated in opposite phase to the inputted signal light through the use of the inputted signal light. An optical band pass filter 9 is provided immediately after the semiconductor optical amplifier 8 to extract only an optical signal with the wavelength λp2 from the optical output from the semiconductor optical amplifier 8. This extracted optical light is inputted to the aforesaid optical coupler 10. At this time, in addition to this extracted optical light, the other probe light with the wavelength λp1 from the optical splitter 3 (the first-mentioned semiconductor laser 2) is also inputted to the same optical coupler 10 as mentioned above. Accordingly, the wavelength λp2 of the extracted optical light from the optical band pass filter 9 and the wavelength λp1 of the other probe light from the optical splitter 3 are multiplexed with each other, thereby producing a multiplexed light with wavelengths λp1+λp2. Subsequently, the multiplexed light with the wavelengths λp1+λp2 is inputted to a further semiconductor optical amplifier 11 so that the probe light with the wavelength λp1 is likewise intensity-modulated in opposite phase to the optical signal with the wavelength λp2. Following this, the optical output of the semiconductor optical amplifier 5 and the optical output of the semiconductor optical amplifier 11 are multiplexed in a further optical coupler 12, then followed by another optical band pass filter 13 to produce and output only an optical signal with the wavelength λp1.

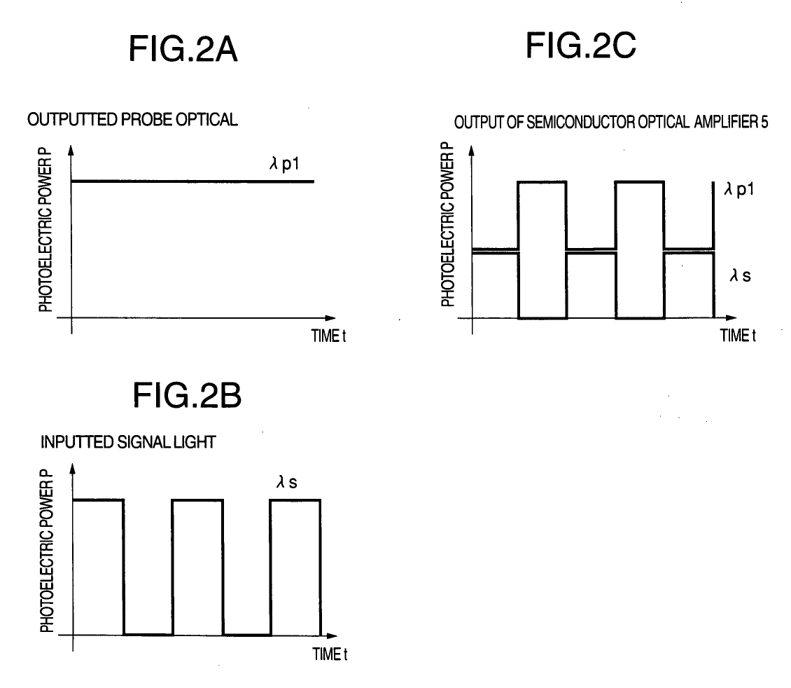

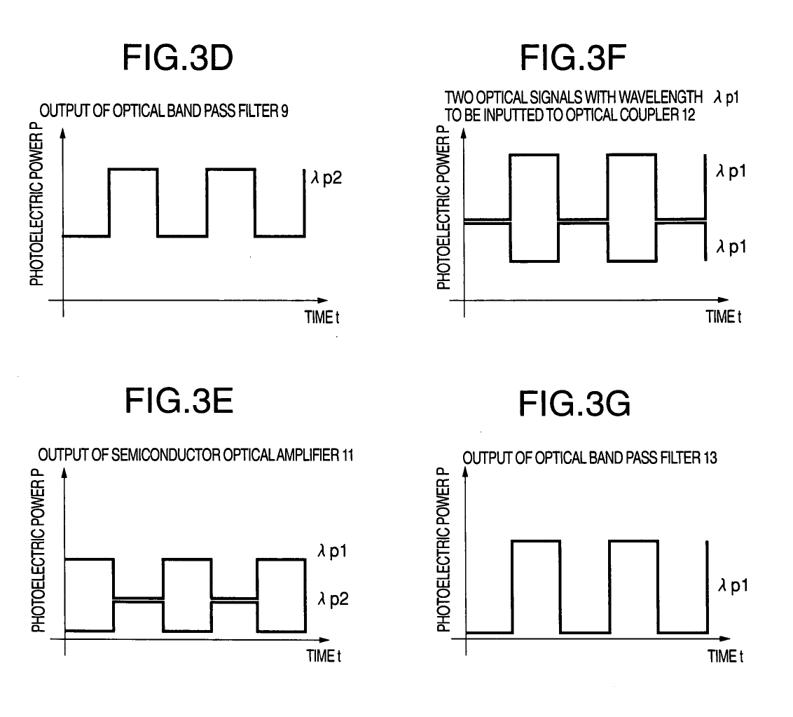

Furthermore, referring to FIGS. 2A to 2C and 3D to 3G, a description will be given hereinbelow of the principle of the wavelength conversion to be implemented in the above-described wavelength converter configuration.

When a probe light with the wavelength λp1 shown in FIG. 2A and a signal light with the wavelength λs shown in FIG. 2B are inputted to the semiconductor optical amplifier 5, the optical intensity of the probe light with the wavelength λp1 is modulated in opposite phase with respect to the wavelength λs signal light as shown in FIG. 2C. Likewise, the probe light with the wavelength λp2 is intensity-modulated in the semiconductor optical amplifier 8 and this intensity-modulated signal with the wavelength λp2 is extracted through the use of the optical band pass filter 9, thereby producing a waveform having a decreased extinction ratio as shown in FIG. 3D. When the optical signal with the wavelength λp2 shown in FIG. 3D is multiplexed with the probe light with the wavelength λp1 in the optical coupler 10 and then inputted to the semiconductor optical amplifier 11, as shown in FIG. 3E, the output of the semiconductor optical amplifier 11 becomes an intensity-modulated signal obtained in a manner such that the probe light with the wavelength λp1 is intensity-modulated in opposite phase with respect to the optical signal with the wavelength λp2.

Accordingly, in a case in which two signals including the wavelength λp1 and being in opposite phase relation to each other shown in FIG. 3F are multiplexed with each other in the optical coupler 12, this functions as a Mach-Zehender interferometer, and if the phases of the two optical signals in the optical domain are shifted by λ/2 from each other, the optical signals tend to cancel each other. In this case, the upper and lower waveforms shown in FIG. 3F, the light falls into a minimum during the time that the photoelectric powers p become close to each other, while the cancellation between the optical signals hardly occurs (slight) when the photoelectric powers are different largely from each other. Therefore, an optical signal with the wavelength λp1 and with a large extinction ratio shown in FIG. 3G is outputted from the optical band pass filter 13.

As described above, in the wavelength converter according to this embodiment, an optical signal with the wavelength λp2, which has an inverted phase with respect to an optical signal with the wavelength λp1 to be outputted, is used to produce a Mach-Zehnder interferometer, thus realizing a wavelength converter capable of suppressing the degradation of the extinction ratio.

(Second Embodiment)

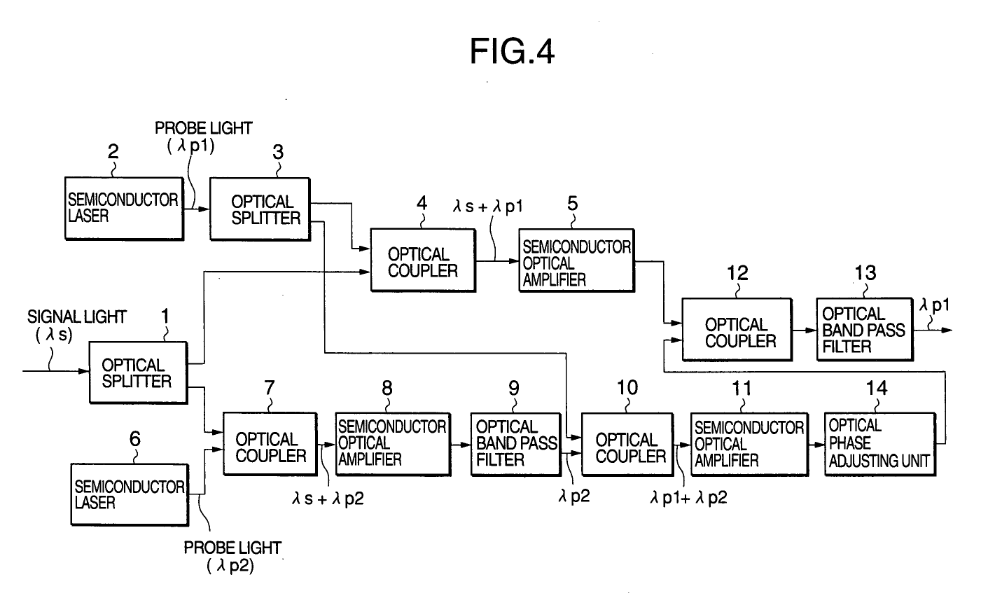

FIG. 4 is an illustration of a configuration of a wavelength converter according to a second embodiment of the present invention. The same parts as those in the above-described first embodiment are marked with the same reference numerals, and the description thereof will be omitted for brevity. A difference of the second embodiment from the first embodiment is additional employment of an optical phase adjusting unit (optical phase variable unit having a function to vary optical phase) 14 between the semiconductor optical amplifier 11 and the optical coupler 12. That is, the optical phase adjusting unit 14 is interposed between the semiconductor optical amplifier 11 and the optical coupler 12 in the configuration of the wavelength converter according to the first embodiment.

This optical phase adjusting unit 14 is made to adjust the phase of the output signal from the semiconductor optical amplifier 11 for adjusting a phase difference between an optical signal advancing from the optical splitter 3 through the semiconductor optical amplifier 5 to the optical coupler 12 and an optical signal advancing from the optical coupler 10 through the semiconductor optical amplifier 11 to the optical coupler 12. The optical phase adjusting unit 14 brings the phase difference in the optical domain closer to λ/2, which can contribute to further improvement of the extinction ratio.

(Third Embodiment)

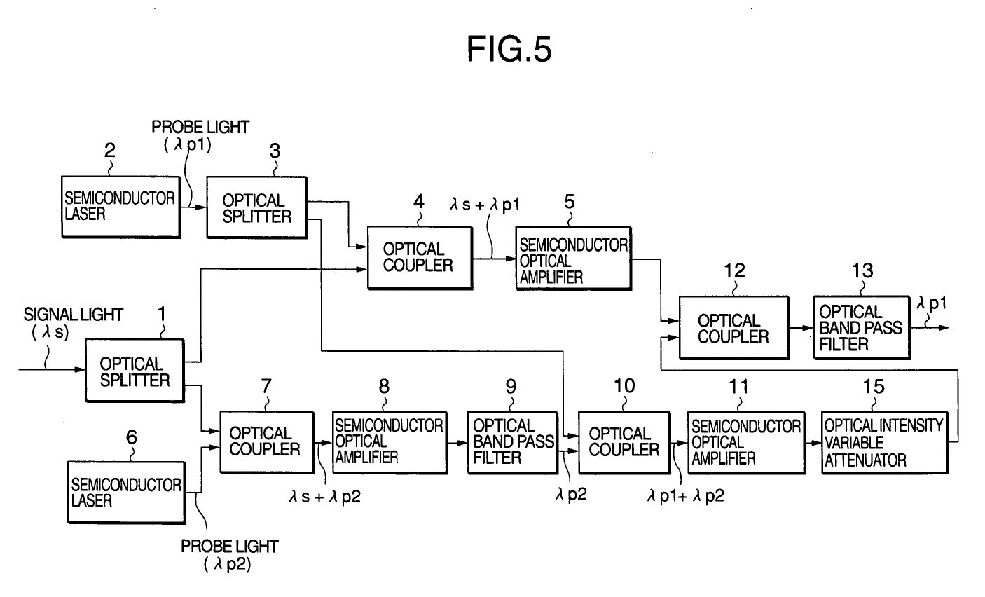

FIG. 5 is an illustration of a configuration of a wavelength converter according to a third embodiment of the present invention. The same parts as those in the above-described first embodiment are marked with the same reference numerals, and the description thereof will be omitted for brevity. A difference of the third embodiment from the first embodiment is additional employment of an optical intensity variable attenuator (optical unit having a function to adjust the optical intensity) 15 between the semiconductor optical amplifier 11 and the optical coupler 12. That is, the optical intensity variable attenuator 15 is interposed between the semiconductor optical amplifier 11 and the optical coupler 12 in the configuration of the wavelength converter according to the first embodiment.

This optical intensity variable attenuator 15 is for adjusting an intensity difference between an optical signal advancing from the optical splitter 3 through the semiconductor optical amplifier 5 to the optical coupler 12 and an optical signal advancing from the optical coupler 10 through the semiconductor optical amplifier 11 to the optical coupler 12. The optical intensity variable attenuator 15 can adjust the optical intensity difference therebetween, which contributes to further improvement of the extinction ratio.

(Fourth Embodiment)

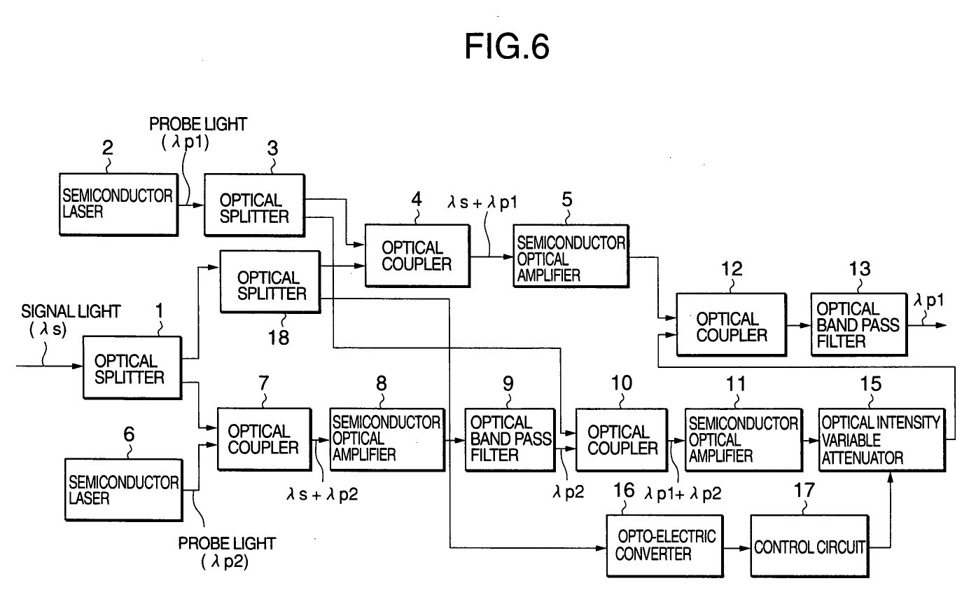

FIG. 6 is an illustration of a configuration of a wavelength converter according to a fourth embodiment of the present invention. The same parts as those in the above-described third embodiment are marked with the same reference numerals, and the description thereof will be omitted for brevity. A difference of the fourth embodiment from the third embodiment is additional employment of an optical splitter 18 between the optical splitter 1 and the optical coupler 4, and an opto-electric converter 16 and a control circuit 17 between the optical splitter 18 and the optical intensity variable attenuator 15. The optical splitter 18 is for further dividing one inputted signal light with the wavelength λs from the optical splitter 1 into two signal lights, with one being inputted to the optical coupler 4 and the other being fed to the opto-electric converter 16. The opto-electric converter 16 is for converting the optical signal from the optical splitter 18 into an electric signal, and the output of this opto-electric converter 16 is inputted to the control circuit 17. This control circuit 17 is for controlling the optical intensity variable attenuator 15. That is, the control circuit 17 is made to monitor an output voltage of the opto-electric converter 16 for controlling the optical intensity variable attenuator 15 on the basis of the output voltage thereof. Thus, this configuration according to the fourth embodiment monitors an average photoelectric power (optical level) of the inputted signal light with the wavelength λs to control the optical intensity variable attenuator 15, thereby automatically achieving the improvement of the extinction ratio in the third embodiment irrespective of a variation in optical level of the inputted signal light.

(Fifth Embodiment)

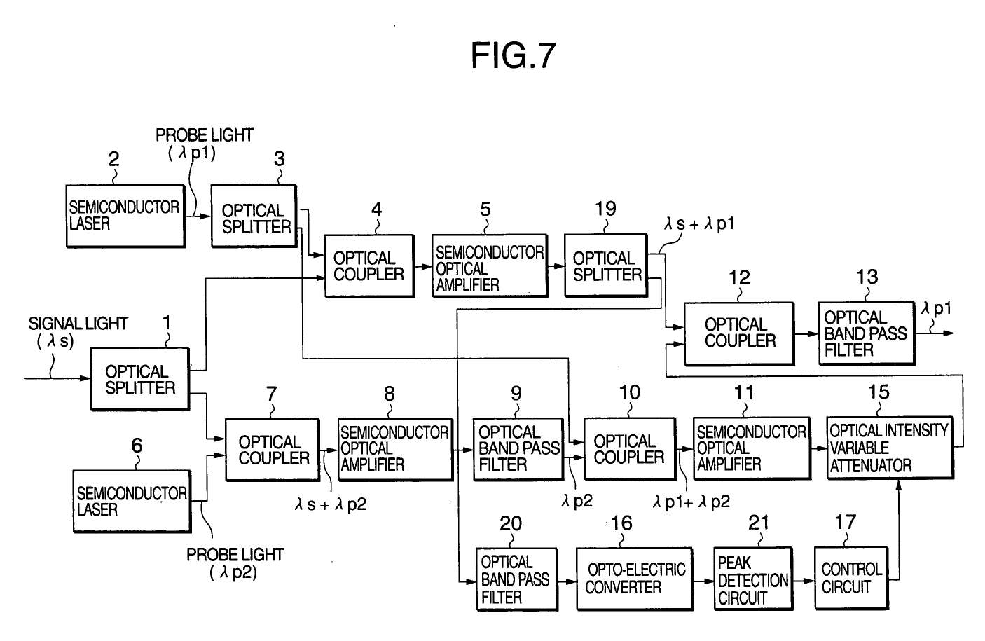

FIG. 7 is an illustration of a configuration of a wavelength converter according to a fifth embodiment of the present invention. The same parts as those in the above-described third embodiment are marked with the same reference numerals, and the description thereof will be omitted for brevity. A difference of the fifth embodiment from the third embodiment is additional employment of an optical splitter 19 between the semiconductor optical amplifier 5 and the optical coupler 12, and an optical band pass filter 20, an opto-electric converter 16, a peak detection circuit 21 and a control circuit 17 between the optical splitter 19 and the optical intensity variable attenuator 15.

The optical splitter 19 placed between the semiconductor optical amplifier 5 and the optical coupler 12 is for dividing the light with the wavelengths λs+λp1 from the semiconductor optical amplifier 5 into two lights, with one being inputted to the optical coupler 12 and the other being inputted to the optical band pass filter 20. This optical band pass filter 20 extracts an optical signal with the wavelength λp1 from an optical signal outputted from the optical splitter 19, i.e., the intensity-modulated light with the wavelengths λs+λp1 from the semiconductor optical amplifier 5. The optical signal after passing through the optical band pass filter 20 is inputted to the opto-electric converter 16 to be converted into an electric signal. This electric signal from the opto-electric converter 16 is inputted to the peak detection circuit 21 to detect a lower-base level (low level) of the electric signal outputted from the opto-electric converter 16. The output optical signal is inputted to the control circuit 17. This control circuit 17 is for controlling the optical intensity variable attenuator 15 so that a level of the output of the peak detection circuit 21 (that is, of the optical signal outputted from the semiconductor optical amplifier 5, a low level of the optical signal with the wavelength λp1) becomes equal to, of the optical signal outputted from the semiconductor optical amplifier 11, a high level of the optical signal with the wavelength λp1. As well as the above-described fourth embodiment, this construction automatically achieve the improvement of the extinction ratio in the third embodiment irrespective of a variation in optical level of the inputted signal light.

(Sixth Embodiment)

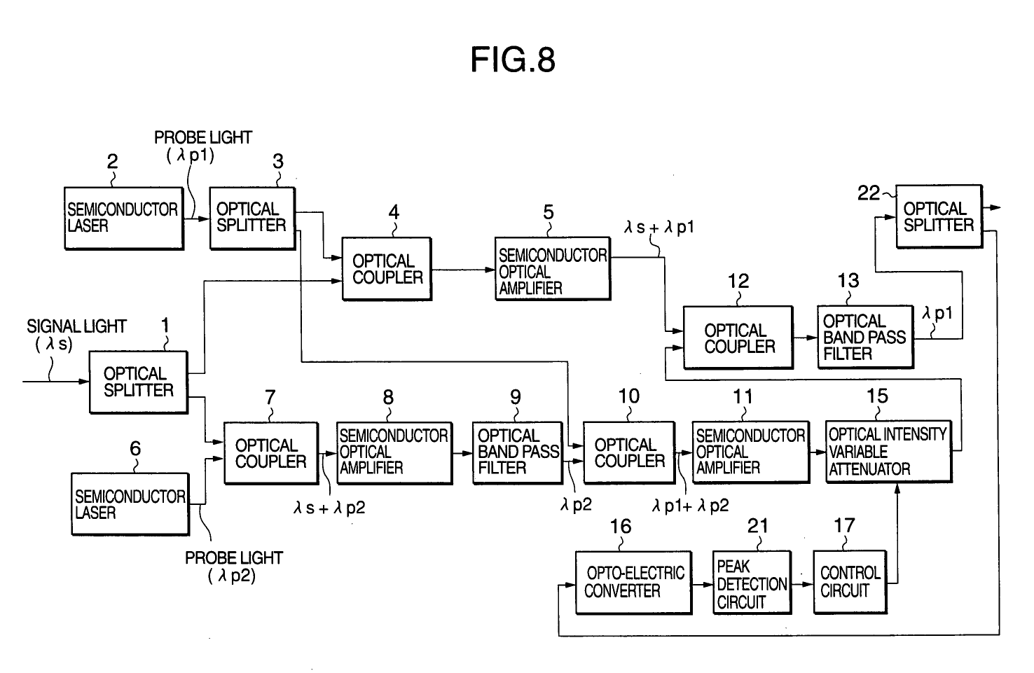

FIG. 8 is an illustration of a configuration of a wavelength converter according to a sixth embodiment of the present invention. The same parts as those in the above-described third embodiment are marked with the same reference numerals, and the description thereof will be omitted for brevity. A difference of the sixth embodiment from the third embodiment is additional employment of an optical splitter 22 at the latter stage of the optical band pass filter 13, and an opto-electric converter 16, a peak detection circuit 21 and a control circuit 17 between the optical splitter 22 and the optical intensity variable attenuator 15. Moreover, a difference from the fifth embodiment is, in place of the optical splitter 19 and the optical band pass filter 20, employment of an optical splitter 22 at the latter stage of the optical band pass filter 13.

The optical splitter 22 is for dividing the optical signal with the wavelength λp1 from the optical band pass filter 13 into two lights, with one being outputted as an output of this apparatus and the other being inputted to the opto-electric converter 16 to be converted into an electric signal. This electric signal from the opto-electric converter 16 is inputted to the peak detection circuit 21, the output optical signal of which is inputted to the control circuit 17. In this case, the peak detection circuit 21 monitors a low level of the optical signal with the wavelength λp1, which is an output of this apparatus, and the control circuit 17 controls the optical intensity variable attenuator 15 so that the low level thereof reaches a minimum. As well as the above-described fifth embodiment, this construction automatically achieve the improvement of the extinction ratio in the third embodiment irrespective of a variation in optical level of the inputted signal light.

(Seventh Embodiment)

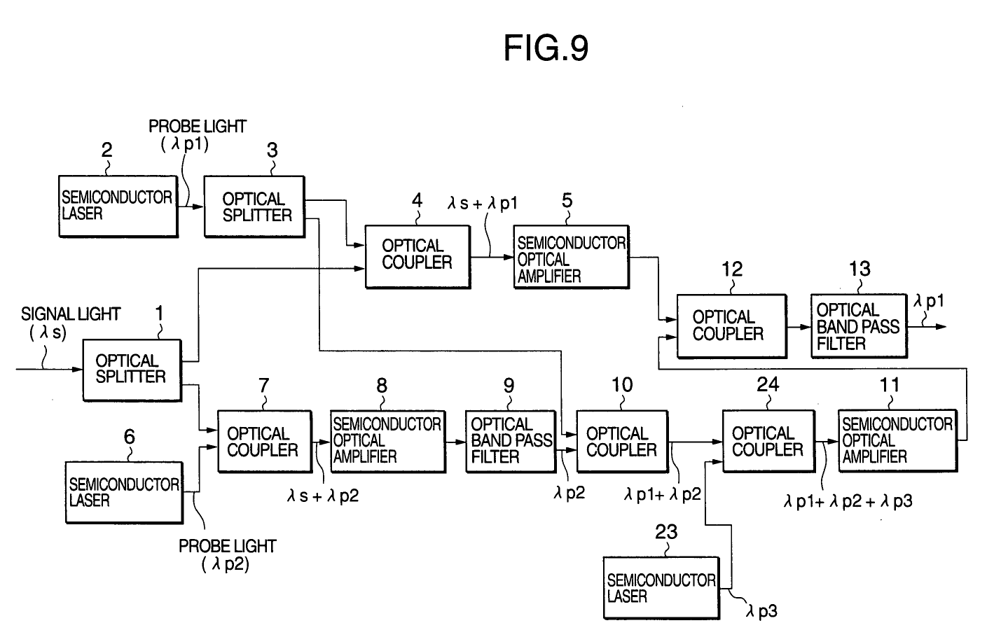

FIG. 9 is an illustration of a configuration of a wavelength converter according to a seventh embodiment of the present invention. The same parts as those in the above-described first embodiment are marked with the same reference numerals, and the description thereof will be omitted for simplicity. A difference of the seventh embodiment from the first embodiment is additional employment of an optical coupler 24 between the optical coupler 10 and the semiconductor optical amplifier 11, and a semiconductor laser 23 connected to the optical coupler 24.

The semiconductor laser 23 is made to output an optical signal with a constant intensity and with a wavelength λp3 different from the foregoing wavelengths λp1 and λp2. The optical signal outputted from the semiconductor laser 23 is inputted to the optical coupler 24. Thus, the optical coupler 24 receives the optical signal with the wavelength λp3 from the semiconductor laser 23 in addition to the optical signal with the wavelengths λp1+λp2 from the optical coupler 10, thereby outputting an optical signal with the wavelengths λp1+λp2+λp3 to the semiconductor optical amplifier 11. This configuration causes the intensity of the optical signal with the wavelength λp1 to be outputted from the semiconductor optical amplifier 11 to vary on the basis of a level of an optical output from the semiconductor laser 23. That is, there exists a phenomenon that, when the optical signal inputted from the semiconductor laser 23 to the semiconductor optical amplifier 11 increases in optical level, the optical signal with the wavelength λp1 to be outputted from the semiconductor optical amplifier 11 decreases in optical level. Accordingly, the configuration of the wavelength converter according to this embodiment utilizes the aforesaid phenomenon to adjust an optical intensity difference between the optical signal going from the optical splitter 3 through the semiconductor optical amplifier 5 to the optical coupler 12 and the optical signal going from the optical splitter 3 through the semiconductor optical amplifier 11 to the optical coupler 12. That is, this is for further improving the extinction ratio through the adjustment of the difference in optical intensity between the two paths. Moreover, also in this configuration, further improvement of the extinction ratio is feasible in a manner such that the optical output level of the semiconductor laser 23 is controlled by monitoring an average photoelectric power of the inputted signal light or monitoring a lower-base intensity level of the optical signal with the wavelength λp1 of the optical output from the semiconductor optical amplifier 5 or the optical band pass filter 13. That is, for further improvement of the extinction ratio, this embodiment can be combined with the above-described embodiments, for example, shown in FIGS. 6 to 8.

(Eighth Embodiment)

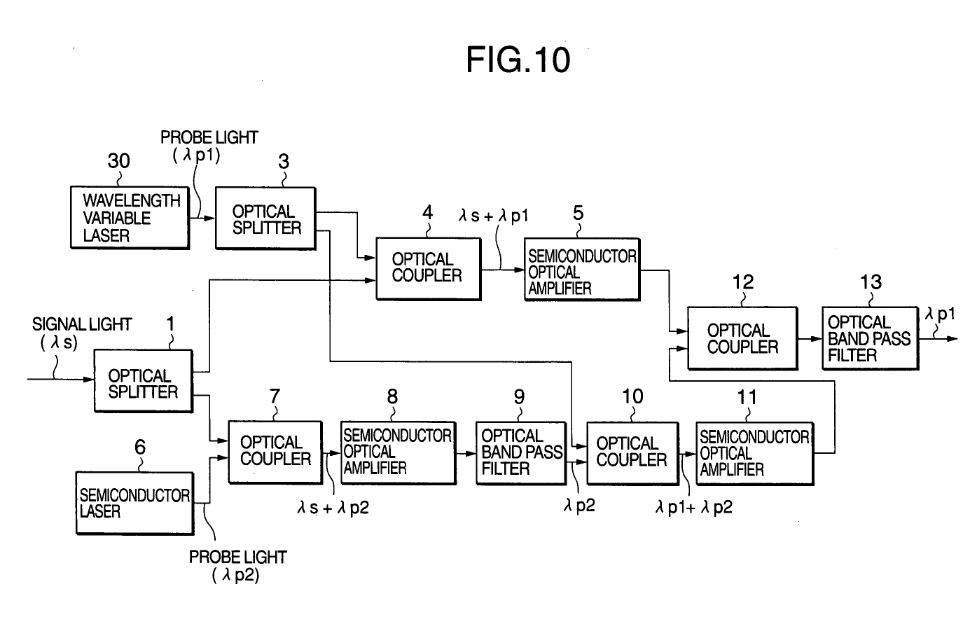

FIG. 10 is an illustration of a configuration of a wavelength converter according to an eighth embodiment of the present invention. The same parts as those in the above-described first embodiment are marked with the same reference numerals, and the description thereof will be omitted for simplicity. A difference of the eighth embodiment from the first embodiment is the employment of a wavelength variable laser 30 in place of the semiconductor laser 2. The employment of the wavelength variable laser 30 allows the wavelength of the probe light to be changed, that is, this enables a proper change of the output wavelength λp1 from this wavelength converter according to situations or purposes.

(Ninth Embodiment)

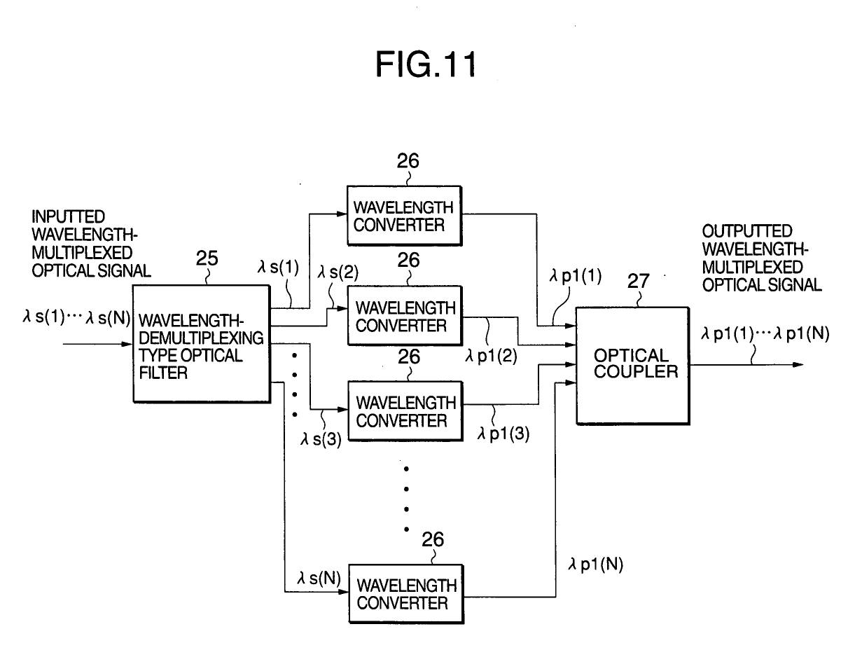

FIG. 11 is an illustration of a configuration of an optical cross connect system according to a ninth embodiment of the present invention. As shown in FIG. 11, the optical cross connect system according to this embodiment is made up of a wavelength-demultiplexing type optical filter 25, a plurality of wavelength converters 26, and an optical coupler 27.

The wavelength-demultiplexing type optical filter 25 is for demultiplexing a multiplexed optical signal with a plurality of different wavelengths λs(1) to λs(N), inputted to this optical cross connect system, into a plurality of optical signals each having the corresponding wavelength. The optical signals with the different wavelengths λs(1) to λs(N), outputted from the wavelength-demultiplexing type optical filter 25, are inputted to the plurality of wavelength converters 26, respectively. Each of the plurality of wavelength converters 26 receives the corresponding optical signal from the wavelength-demultiplexing type optical filter 25 as an inputted signal light and carries out the wavelength conversion on the signal light, inputted thereto, to output an optical signal with the corresponding wavelength λp1. In this case, each of the wavelength converters 26 is of a type equivalent to the wavelength converter according to the eighth embodiment, including a wavelength variable laser.

That is, each of the waveform converters 26, connected to the wavelength-demultiplexing type optical filter 25 for receiving each of the corresponding optical signals as inputted signal light, includes a first wavelength-variable type laser for outputting light with a constant intensity and with a first wavelength forming a wavelength to be obtained when the corresponding inputted signal light undergoes wavelength conversion in this wavelength converter, a first semiconductor optical amplifier for intensity-modulating the output light with the first wavelength from the first semiconductor laser through the use of the inputted signal light so that the output light falls into an opposite phase condition with respect to the inputted signal light, a second semiconductor laser for outputting a light with a constant intensity and with a second wavelength different from that of the inputted signal light and that of the output light from the first semiconductor laser, a second semiconductor optical amplifier for intensity-modulating the output light with the second wavelength from the second semiconductor laser through the use of the inputted signal light so that the output light falls into an opposite phase condition with respect to the inputted signal light, a first filter for extracting a light with the second wavelength from the output light from the second semiconductor optical amplifier, a third semiconductor optical amplifier for intensity-modulating the output light with the first wavelength from the first semiconductor laser through the use of the light with the second wavelength extracted through the first filter so that the output light falls into an opposite phase condition with respect to the second-wavelength light, multiplexer for multiplexing the output lights from the first and third semiconductor optical amplifiers, and a second filter for extracting a light with the first wavelength from a multiplexed light from the multiplexer.

The optical signals with different wavelengths λp1(1) to λp1(N) respectively outputted from the wavelength converters 26 are inputted to the optical coupler 27 to multiplex the optical signals outputted therefrom.

This configuration performs the wavelength conversion on each of the wavelengths of an inputted wavelength-multiplexed optical signal and again carries out the multiplexing of the converted wavelengths, that is, it organizes an optical cross connect system.

It should be understood that the present invention is not limited to the above-described embodiments, and that it is intended to cover all changes and modifications of the embodiments of the invention herein which do not constitute departures from the spirit and scope of the invention.

What is claimed is:

1. A wavelength converter comprising:
a first semiconductor laser for outputting light with a constant intensity and with a first wavelength forming a wavelength to be obtained when a signal light is inputted to said wavelength converter and undergoes wavelength conversion in said wavelength converter;
a first semiconductor optical amplifier for intensity-modulating the output light with said first wavelength from said first semiconductor laser through the use of the inputted signal light so that the output light falls into an opposite phase condition with respect to the inputted signal light;
a second semiconductor laser for outputting a light with a constant intensity and with a second wavelength different from that of the inputted signal light and that of the output light from said first semiconductor laser;
a second semiconductor optical amplifier for intensity-modulating the output light with said second wavelength from said second semiconductor laser through the use of the inputted signal light so that the output light falls into an opposite phase condition with respect to the inputted signal light;
a first filter for extracting a light with said second wavelength from the output light from said second semiconductor optical amplifier;
a third semiconductor optical amplifier for intensity-modulating the output light with said first wavelength from said first semiconductor laser through the use of said light with said second wavelength extracted through said first filter so that the output light falls into an opposite phase condition with respect to said second-wavelength light;
multiplexing means for multiplexing the output lights from said first and third semiconductor optical amplifiers; and
a second filter for extracting a light with said first wavelength from a multiplexed light from said multiplexing means.

2. The wavelength converter according to claim 1, further comprising optical phase adjusting means interposed between said third semiconductor optical amplifier and said multiplexing means to adjust a phase of the output light from said third semiconductor optical amplifier for adjusting a phase difference between the output light from said first semiconductor optical amplifier and the output light from said third semiconductor optical amplifier.

3. The wavelength converter according to claim 1, further comprising an optical intensity adjusting unit interposed between said third semiconductor optical amplifier and said multiplexing means to adjust an optical intensity of the output light from said third semiconductor optical amplifier with respect to the output light from said first semiconductor optical amplifier.

4. The wavelength converter according to claim 3, further comprising:
an opto-electric converter for receiving the inputted signal light to convert the inputted signal light into an electric signal; and
a control circuit responsive to said electric signal from said opto-electric converter to monitor an average photoelectric power of the inputted signal light for controlling said optical intensity adjusting unit on the basis of said average photoelectric power of the inputted signal light for adjusting the optical intensity of the output light from said third semiconductor optical amplifier.

5. The wavelength converter according to claim 3, further comprising:
a third filter for extracting a light with said first wavelength from the output light from said first semiconductor optical amplifier;
an opto-electric converter for receiving the extracted light from said third filter to convert the extracted light into an electric signal;
a peak detection circuit for receiving the converted electric signal outputted from said opto-electric converter to detect a lower-base intensity level of the converted electric signal, and
a control circuit for receiving the lower-base intensity level of the converted electric signal to monitor a lower-base intensity level of the output light with said first wavelength from said first semiconductor optical amplifier for controlling said optical intensity adjusting unit on the basis of said lower-base intensity level of the output light with first wavelength to adjust the optical intensity of the output light from said third semiconductor optical amplifier.

6. The wavelength converter according to claim 3, further comprising:
an opto-electric converter connected to said second filter for receiving the extracted light with said first wavelength from said second filter to convert the extracted light into an electric signal;
a peak detection circuit for receiving the converted electric signal outputted from said opto-electric converter to detect a lower-base intensity level of the converted electric signal, and
a control circuit for receiving the lower-base intensity level of the converted electric signal to monitor a lower-base intensity level of the output light with said first wavelength from said first semiconductor optical amplifier for controlling said optical intensity adjusting unit on the basis of said lower-base intensity level of the output light with first wavelength to adjust the optical intensity of the output light from said third semiconductor optical amplifier.

7. The wavelength converter according to claim 1, further comprising:
a third semiconductor laser for outputting a light with a constant intensity and with a third wavelength;
second multiplexing means connected to said third semiconductor optical amplifier and further connected to said first to third semiconductor laser for multiplexing the output lights from said first to third semiconductor lasers, with the multiplexed light with said first to third wavelengths being inputted to said third semiconductor optical amplifier.

8. The wavelength converter according to claim 7, further comprising:
an opto-electric converter for receiving the inputted signal light to convert the inputted signal light into an electric signal; and
a control circuit responsive to said electric signal from said opto-electric converter to monitor an average photoelectric power of the inputted signal light for controlling said optical intensity adjusting unit on the basis of said average photoelectric power of the inputted signal light for adjusting the optical intensity of the output light from said third semiconductor optical amplifier.

9. The wavelength converter according to claim 7, further comprising:
a third filter for extracting a light with said first wavelength from the output light from said first semiconductor optical amplifier;
an opto-electric converter for receiving the extracted light from said third filter to convert the extracted light into an electric signal;
a peak detection circuit for receiving the converted electric signal outputted from said opto-electric converter to detect a lower-base intensity level of the converted electric signal, and
a control circuit for receiving the lower-base intensity level of the converted electric signal to monitor a lower-base intensity level of the output light with said first wavelength from said first semiconductor optical amplifier for controlling said optical intensity adjusting unit on the basis of said lower-base intensity level of the output light with first wavelength to adjust the optical intensity of the output light from said third semiconductor optical amplifier.

10. The wavelength converter according to claim 7, further comprising:
an opto-electric converter connected to said second filter for receiving the extracted light with said first wavelength from said second filter to convert the extracted light into an electric signal;
a peak detection circuit for receiving the converted electric signal outputted from said opto-electric converter to detect a lower-base intensity level of the converted electric signal, and
a control circuit for receiving the lower-base intensity level of the converted electric signal to monitor a lower-base intensity level of the output light with said first wavelength from said first semiconductor optical amplifier for controlling said optical intensity adjusting unit on the basis of said lower-base intensity level of the output light with first wavelength to adjust the optical intensity of the output light from said third semiconductor optical amplifier.

11. The wavelength converter according to claim 1, wherein a portion of or all of the components of said wavelength converter are formed on a semiconductor substrate in an integrated condition.

12. The wavelength converter according to claim 1, wherein said first semiconductor laser is a wavelength-variable type laser.

13. An optical cross connect system comprising:
a wavelength-demultiplexing type optical filter for demultiplexing a multiplexed optical signal with a plurality of wavelengths into a plurality of optical signals each having the corresponding wavelength;
a plurality of wavelength converters connected to said wavelength-demultiplexing type optical filter for receiving said plurality of optical signals as inputted signal lights, each of said wavelength converters including:
a first wavelength-variable type semiconductor laser for outputting a light with a constant intensity and with a first wavelength forming a wavelength to be obtained when the corresponding inputted signal light undergoes wavelength conversion in this wavelength converter;
a first semiconductor optical amplifier for intensity-modulating the output light with said first wavelength from said first semiconductor laser through the use of the inputted signal light so that the output light falls into an opposite phase condition with respect to the inputted signal light;
a second semiconductor laser for outputting a light with a constant intensity and with a second wavelength different from that of the inputted signal light and that of the output light from said first semiconductor laser;
a second semiconductor optical amplifier for intensity-modulating the output light with said second wavelength from said second semiconductor laser through the use of the inputted signal light so that the output light falls into an opposite phase condition with respect to the inputted signal light;
a first filter for extracting a light with said second wavelength from the output light from said second semiconductor optical amplifier;
a third semiconductor optical amplifier for intensity-modulating the output light with said first wavelength from said first semiconductor laser through the use of the light with said second wavelength extracted through said first filter so that the output light falls into an opposite phase condition with respect to the second-wavelength light;
multiplexing means for multiplexing the output lights from said first and third semiconductor optical amplifiers; and
a second filter for extracting a light with said first wavelength from a multiplexed light from said multiplexing means; and
an optical coupler for multiplexing the extracted lights outputted from of said second filters of said plurality of wavelength converters.
